(19) United States
(12) Patent Application Publication
(10) Pub. No.: US 2015/0161623 A1
(43) Pub. Date: Jun. 11, 2015

(54) GENERATING CUSTOMER PROFILES USING TEMPORAL BEHAVIOR MAPS

(71) Applicant: FAIR ISAAC CORPORATION, San Jose, CA (US)

(72) Inventors: Shafi Ur Rahman, Bangalore (IN); Rakhi Agrawal, Pantnagar (IN); Amit Kiran Sowani, Bangalore (IN); Manmeet Kaur, Bangalore (IN); Arjun Bajaj, Bangalore (IN)

(73) Assignee: FAIR ISAAC CORPORATION, San Jose, CA (US)

(21) Appl. No.: 14/102,374

(22) Filed: Dec. 10, 2013

(51) Int. Cl. G06Q 30/02; G06Q 40/00

(52) U.S. Cl. CPC G06Q 30/0201; G06Q 40/12

(57) ABSTRACT

A customer profile is generated for a customer performing one or more transactions using temporal behavior maps in order to determine a score that can be used by an entity to determine offers for the customer. The temporal behavior maps can characterize a purchase behavior of the customer. Related apparatus, systems, techniques and articles are also described.

### TECHNICAL FIELD

The subject matter described herein relates to generating a customer profile using temporal behavior maps in order to determine a decision for the customer.

### BACKGROUND

Various financial institutions use scores for customers in order to make lending decisions. Similarly, retailers use scores of customers to make decisions regarding offers or discounts to those customers. These scores are usually generated based on profiles of the customers. A profile for a customer can include various behavioral characteristics derived based on past transactions performed by the customer. Traditionally, customer profiles have been generated by some recursive and iterative approaches. However, these traditional approaches of generating a customer profile suffer from various drawbacks. For example, some of the conventional methods generate approximate values associated with customer profiles rather than accurate values. Moreover, coding required for generating the customer profile is conventionally unintuitive and complex. Further, if an error occurs due to a spurious transaction while generating a customer profile, the whole customer profile is required traditionally to be recomputed from scratch. Additionally, generation of customer profiles is associated with significant latency issues while using traditional methodologies that rely on an iterative approach. Furthermore, some of the conventional methods for generating a customer profile require intensive computational resources, such as a large number of data processors and a significant memory space.

### SUMMARY

The current subject matter describes generating a profile of a customer performing one or more transactions in order to determine a decision for the customer. The customer profile can be generated based on temporal behavior maps formed or updated using the one or more transactions.

In one aspect, one or more back-end server computers can receive transaction data of one or more transactions performed by a customer. The one or more back-end server computers can generate a plurality of temporal behavior maps based on the transaction data. The temporal behavior maps can characterize purchase behavior of the customer. The one or more back-end server computers can generate a customer profile of the customer based on the plurality of temporal behavior maps. The customer profile can be used by a decision engine to generate a decision for the customer. The decision engine can include at least one data processor connected to the one or more back-end computers.

In some variations, one or more of the following can be implemented individually or in any suitable combination. The one or more back-end server computers can include an aggregator module and a generator module that can be connected to the aggregator module. The decision engine can be connected to the generator module. The aggregator module can receive the transaction data of the one or more transactions performed to generate the plurality of temporal behavior maps. The generator module can receive the plurality of temporal behavior maps to generate the customer profile. The aggregator module can receive the transaction data in real-time when the customer performs a new transaction. The aggregator module can receive the transaction data in a batch including a plurality of transactions previously performed by the customer. The aggregator module can receive the transaction data in batches of continuously updating transactions performed by the customer in real-time. The one or more transactions can be performed by the customer on a front end client computer connected to the one or more back-end server computers via a communication network. The transaction data can include an identifier of the customer, period of each transaction, one or more products purchased by the customer in each transaction, a price of each purchased product, quantity of products purchased by the customer, transaction type of each transaction performed by the customer, and merchant category code of one or more merchants associated with each transaction.

Further, the plurality of temporal behavior maps can include one or more of at least a frequency base map, a recency base map, a price base map, a total products base map, a unique products base map, a visits base map, a stock keeping unit (SKU) base map, and a date base map. The frequency base map can be represented as a map of {period: {product1: frequency, product2: frequency, . . . }}. The recency base map can be represented as a map of {product: {list of periods in which the product is purchased}}. The price base map can be represented as a map of {period: total money spent in the time period, . . . }. The total products base map can be represented as a map of {period: total number of products purchased, . . . }. The unique products base map can be represented as a map of {period: number of unique products purchased, . . . }. The visits base map can be represented as a map of {period: total number of customer visits, . . . }. The stock keeping unit (SKU) base map can be represented as a map of {period: list of unique SKUs purchases by customer, . . . }. The date base map can be represented as a map of {period: date of most recent purchase, . . . }.

Further, the generator module can include a frequency generator, a recency generator, and a transaction variables generator. The frequency generator can generate one or more frequency variables based on a frequency base map of the plurality of temporal behavior maps. The recency generator can generate one or more recency variables based on a recency base map. The transaction variables generator can generate one or more transaction variables based on at least one of a price base map, a total products base map, a unique products base map, a visits base map, a stock keeping unit (SKU) base map, and a date base map of the plurality of temporal behavior maps. The customer profile can be characterized by at least the one or more frequency variables, the one or more recency variables, and the one or more transaction variables. The decision engine can be a scoring engine, and the decision can be a score generated by the scoring engine. The score can be used by one of a financial institution and a retailer to make an offer to the customer. The offer can include one of: an increase in a credit line of a credit card of the customer, and discounts on one or more products.

In another aspect, a customer profile of a customer characterizing one or more behavioral characteristics of the customer can be received by at least one programmable processor activated by instructions stored in a non-transitory computer program product. The customer profile can be based on one or more temporal behavior maps characterizing a purchase behavior of the customer over discrete periods of time. The one or more temporal behavior maps can be based on one or more transactions performed by the customer. The at least one programmable processor can generate, based on the customer profile, a decision for the customer for use by an entity to make one or more offers to the customer.

In some variations, one or more of the of the following can be implemented individually or in any suitable combination. The entity can be one of a financial institution and a retailer. The one or more offers can include one or more of: an increase in credit line of a credit card of the customer, and discounts on one or more products.

In yet another aspect, a system can include a client computing system and one or more back-end server computers connected to the client computing system via a communication network. The client computing system can include at least one hardware data processor and a storage memory device. The client computing system can be used by a customer to perform one or more transactions. The one or more back-end server computers can receive transaction data of the one or more transactions performed on the client computing system. The one or more back-end server computers can generate a plurality of temporal behavior maps based on the transaction data. The temporal behavior maps can characterize a purchase behavior of the customer. The one or more back-end server computers can generate a customer profile of the customer based on the plurality of temporal behavior maps. The customer profile can be used by a decision engine to generate a decision for the customer. The decision engine can include at least one data processor connected to the one or more back-end computers.

In some variations, one or more of the of the following can be implemented individually or in any suitable combination. The one or more back-end server computers can include an aggregator module and a generator module that is connected to the aggregator module. The decision engine can be connected to the generator module. The aggregator module can receive the transaction data of the one or more transactions performed to generate the plurality of temporal behavior maps. The generator module can receive the plurality of temporal behavior maps to generate the customer profile.

Computer program products are also described that include non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless network, a local area network, a wide area network, a wired network, or the like), via a direct connection (wired or peer-to-peer wireless) between one or more of the computing systems, etc.

The subject matter described herein provides many advantages. For example, customer profiles as described herein can include accurate values rather than approximate values. Moreover, the coding required for generating customer profiles and associated decisions can be intuitive. Further, in case of an error due to spurious transactions, just the relevant part of a temporal behavior map needs to be recomputed rather than restarting from scratch the computing of the customer profile. Furthermore, the generation of customer profiles can have a significantly low latency, and can be computationally inexpensive. Moreover, the generation of customer profiles, as described herein, may require lower computing resources, such as computing data processors and computing memory storage. Further, the system described herein allows a user to easily modify (for example, add, delete, and/or change) characteristics of the customer, the base maps, or other data elements without changing the framework, thereby enabling scalability and extensibility of the system. More specifically, the only way to introduce any change is through coding. The key is that the changes required are minimal, easy and do not break down the framework. Therefore, the system is extremely scalable. Additionally, the system allows an easy deployment of changes made from one environment (for example, a modeling environment) to another environment (for example, a production environment) without any changes in the code, thereby enabling portability of the system.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 illustrates a process for generating a customer profile in a batch-mode based on a batch of transactions performed by a customer and generating a decision for the customer based on the customer profile;

FIG. 2 illustrates an example of the process for generating a customer profile in a batch-mode based on a batch of transactions performed by a customer and generating a decision for the customer based on the customer profile;

FIG. 3 illustrates a process for generating a customer profile in real-time in a real-time mode based on an individual transaction performed by a customer and generating a decision for the customer based on the customer profile;

FIG. 4 illustrates a process flow diagram for generating a customer profile in real-time in a real-time mode based on an individual transaction performed by a customer;

FIG. 5 illustrates an example of a process for generating a customer profile in real-time in a real-time mode based on an individual transaction performed by a customer and generating a decision for the customer based on the customer profile; and

FIG. 6 illustrates a process for generating a customer profile in real-time in an incremental mode based on a constantly updating batch of transactions performed by a customer and generating a decision for the customer based on the customer profile.

Like reference symbols in the various drawings indicate like elements.

### DETAILED DESCRIPTION

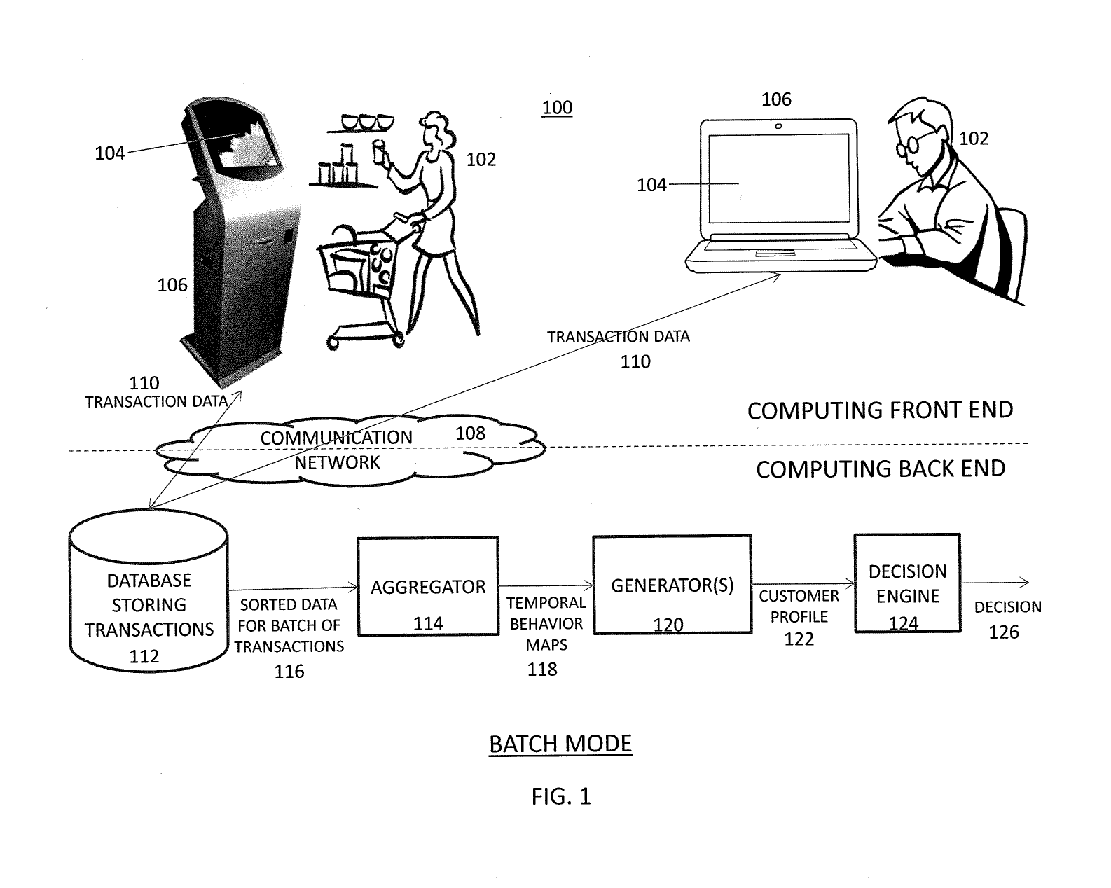

FIG. 1 illustrates a process 100 for generating a customer profile in a batch-mode based on a batch of transactions performed by a customer and generating a decision for the customer based on the customer profile. At the computing front end, various customers 102 can perform transactions using transaction processing computing applications 104 executed on respective computing systems 106. The customer 102 can be an individual or an entity. In one possible variation, the customer 102 can be a machine, which may be automated. The computing systems 106 can be connected via a communication network 108 to a database 112. The database 112 can receive transaction data 110 of transactions of the customers 102 from the computing systems 106 in real-time or in a batch mode. The database 112 can store this transaction data. An aggregator 114 can receive sorted transaction data 116 for a batch of transactions performed by a particular customer, for which a customer profile is to be generated. The aggregator 114 can generate temporal behavior maps 118 based on the sorted transaction data 116 for the particular customer. One or more generators 120 can receive the temporal behavior maps 118 from the aggregator 114. The one or more generators 120 can generate the customer profile 122 of the particular customer. A decision engine can receive the customer profile 122 from the one or more generators 120. The decision engine can generate a decision 126 based on the customer profile 122.

The computing system 106 can include at least one data processor connected to memory storage. This at least one data processor can execute the transaction processing computing application 104, and the memory storage can store data associated with the transaction processing computing application 104. The computing system can be a computer, a laptop computer, a tablet computer, a computing kiosk, a mobile phone, a cellular phone, a pager, any other computing device, or any other similar device. At least one data processor at the computing back end can execute the database 112, the aggregator 114, the one or more generators 120, and the decision engine 124. In one variation, two or more of the database 112, the aggregator 114, the one or more generators 120, and the decision engine 124 can be executed on separate corresponding sets of one or more data processors. The communication network 108 can be at least one of: a local area network, a wide area network, internet, intranet, Bluetooth network, infrared network, and other networks.

The transaction data 110 can include a unique identifier for each customer 102, a period (that is, a numeric value characterizing a corresponding time period) for each transaction performed by each customer 102, each product associated with each transaction performed by each customer 102, and a price for each product purchased by the customer 102 in the transaction. The time period described herein can refer to a discrete amount of time beginning from a beginning past date (also referred to as point of singularity, which can be a global start date used for incremental and real-time usage of temporal behavior maps) to a current date. The database 112 can be an in-memory database, a columnar database, a relational database, a flat-file database, a hierarchical database, and/or any other type of database. The database 112 can allow a random access of data stored within the database 112. More specifically, the database 112 can allow a quick and efficient non-linear search of data stored within the database 112. For example, the database 112 can quickly return data for a stored temporal behavior map 118 for a particular customer 102 when the database 112 receives an identifier identifying the particular customer 112.

The aggregator 114 can be a software module that generates temporal behavior maps 118 based on sorted transaction data 116. The sorted transaction data 116 can include the transaction data 110 for a particular customer 102. For example, the sorted transaction data 116 can be transaction data 110 for a particular customer C1. The temporal behavior maps 118 can include one or more of: a frequency base map, a recency base map, a price base map, a total products base map, a unique products base map, a visits base map, a stock keeping unit (SKU) base map, and a last date base map. Each base map can be stored in a computing memory storage as a corresponding data structure.

The frequency base map can characterize frequency of purchase of various products in corresponding periods (that is, a numeric values characterizing corresponding time periods). The frequency base map can be represented as a map of {period: {product1: frequency, product2: frequency, . . . }}. The recency base map can characterize a time period of most recent purchase of each product. The recency base map can be represented as a map of {product: {list of periods in which the product is purchased}}. The price base map can characterize a total money spent by the customer 102 in each time period. The price base map can be represented as a map of {period: total money spent in the time period, . . . }. The total products base map can characterize a total number of products purchased by the customer 102 in each time period. The total products based map can be represented as a map of {period: total number of products purchased, . . . }. The unique products base map can characterize a number of unique products purchased by the customer 102 in each time period. The unique products base map can be represented as a map of {period: number of unique products purchased, . . . }. The visits base map can characterize a total number of times a customer 102 visits a retailer selling relevant products in each time period. The visits base map can be represented as a map of {period: total number of customer visits, . . . }. The SKU base map can characterize different products purchased by a customer in each time period. The SKU base map can be represented as a map of {period: list of unique SKUs purchases by customer, . . . }. The SKU base map is required for the correct computation of the unique products bought by a customer in a time period. The date map can characterize a date of most recent purchase in each time period. The date map can be represented as a map of {period: date of most recent purchase, . . . }. The date map can be required for the correct computation of the number of customer visits in a time period. As time periods pass and more transactions occur, the temporal behavior maps 118 become larger. The aggregator 114 can discard irrelevant past periods and associated data from the temporal behavior maps 118 when the temporal behavior maps 118 become larger than a threshold length. This discarding of data associated with irrelevant time periods from the temporal behavior maps 118 can be referred to as trimming or pruning of the temporal behavior maps 118. The aggregator can trim the temporal behavior maps periodically (that is, at regular intervals of time). In one example, where data for just the past 24 months is relevant for a particular temporal behavior map, the data associated with time periods prior to the most recent 24 months can be trimmed or pruned at regular intervals of time.

The one or more generators 120 can form a software module that can generate a customer profile 122 for a particular customer 102 based on temporal behavior maps 118 for the particular customer 102. The one or more generators 120 can include multiple generators, such as a recency generator, a frequency generator, a transaction variables generator, and other suitable generators. The recency generator can generate one or more recency variables (described below in more detail) by computing those variables using the recency base map of the temporal behavior maps 118. The frequency generator can generate one or more frequency variables (described below in more detail) by computing those variables using the frequency base map of the temporal behavior maps 118. The transaction variables generator can generate one or more transaction variables (described below in more detail) by computing those variables using one or more of the price base map, the total products base map, the unique products base map, the visits base map, the stock keeping unit (SKU) base map, and the date map of the temporal behavior maps 118.

The recency variables represent characteristics of the customer 102 that are related to the recency of purchase of various products by the customer 102. The recency variables generated by the recency generator can include Recency(product X) and Recency(products_all). Recency(products_all) is referred to as r_all in some of the figures. The variable Recency(product X) can characterize a recency of a most recent purchase of a product X. The recency of the most recent purchase of the product X can characterize how recently the customer 102 purchased the product X, in a predetermined constant observation window. The variable Recency(product X) can be expressed in a number of periods, which can be 12 months, 24 months, 36 months, or the like. The variable Recency(products_all) can characterize a recency of a most recent purchase of any product. The recency of the most recent purchase of any product can characterize how recently the customer purchased the most recently purchased product in a predetermined fixed observation window. The variable Recency(products_all) can be expressed in a number of time periods, which can be 12 months, 24 months, 36 months, or the like. Although Recency(product X) and Recency(products_all) have been described, other recency variables can also be used.

The frequency variables represent characteristics of the customer 102 that are related to the frequency of purchase of various products by the customer 102.

The frequency variables generated by the frequency generator can include Frequency(product X) and Frequency(products_all). Frequency(products_all) is referred to as f_all in some of the figures. The variable Frequency(product X) can characterize a frequency or count of purchases of a product X by the customer 102 in a predetermined observation window (which can be formed of one or more time periods in some implementations), wherein length of each observation time window can be 12 months, 24 months, 36 months, or the like. The variable Frequency(products_all) can characterize a frequency or count of all purchases by the customer 102 in the particular observation time window. Although Frequency(products X) and Frequency(products_all) have been described, other frequency variables can also be used.

The transaction variables represent characteristics of the customer 102 that are related to transaction-related patterns of the customer 102, as described below in more detail. The transaction variables generated by the transaction variables generator can include avg_spend_Nm and total_spend_Nm. The variable avg_spend_Nm can characterize average amount of money spent per month by the customer 102 in N months, wherein N can be 2 months, 3 months, 6 months, 9 months, 12 months, or the like. The variable total_spend_Nm can characterize a total amount of money spent by the customer 102 in N months. The transaction variables can further include: volume variables, fraction variables, and average variables, as described below. Although volume variables, fraction variables, and average variables are described, other variables can additionally or alternately be used.

Volume Variables: The volume variables can include customer basket variables, price variables, and customer basket and price combination variables. The customer basket variables can include a PURCHASE_VISITS variable, a PRODUCTS_BOUGHT variable, a UNIQUE_PRODUCTS_BOUGHT variable, a PRODUCTS_BOUGHT_PER_PURCHASE_VISIT variable, and a BASKET_SIZE variable. The price variables can include a TOTAL_SPEND variable. The customer basket and price combination variables can include a TOTAL_SPEND_PER_VISIT variable and a TOTAL_SPEND_PER_PRODUCT variable.

The PURCHASE_VISITS can be defined as a number of customer's baskets in a particular observation time window, which can span 2 months, 3 months, 6 months, 9 months, 12 months, or the like. A customer basket can be defined as a collection of products purchased by a customer 102 in a single financial transaction or a retail transaction. The PRODUCTS_BOUGHT variable can be defined as a number of total products bought by the customer 102 in the observation window. The UNIQUE_PRODUCTS_BOUGHT variable can be defined as a total number of unique products bought by the customer 102 in the observation window. The PRODUCTS_BOUGHT_PER_PURCHASE_VISIT variable can be defined as an average number of unique products bought per month by the customer 102 in the observation window. The BASKET_SIZE variable can be defined as an average basket size (that is, number of products on an average within one basket) in the observation window. The TOTAL_SPEND variable can be defined as a total amount of money spent by the customer 102 in the observation window. The TOTAL_SPEND_PER_VISIT variable can be defined as an average amount of money spent in each customer basket in the observation window. The TOTAL_SPEND_PER_PRODUCT variable can be defined as average amount of money spent per unique product in the observation window.

Fraction variables: The fraction variables can include a ratio of a value in a current time period to a value in a previous time period. The fraction variables can be computed for all volume variables, for all time periods (for example, 2 months, 3 months, 6 months, 9 months, 12 months, and/or other time periods), and for both equal time periods and unequal time periods. A variable in an equal time period can be a ratio of a value associated with a particular observation window in a current time period to a value associated with the particular observation window in a previous time period. A variable in an unequal time period can be a ratio of a value associated with a first observation time window in a current time period to a value associated with a sum of a first observation time window and a second observation time window in a previous time period. In these variables, each observation time window can be smaller than the corresponding time period.

Averages variables: The average variables can have average values rather than cumulative values. The average variables can include a total_spend variable, a total_products_bought variable, a unique_products_bought variable, and a purchase_visits variable, definitions of which are self-implicative. For the average variables, all observation time windows can include at least one time period.

All these variables generated by the one or more generators 120 using the temporal behavior maps 118 can characterize the characteristics of the customer 102. These variables/characteristics can collectively form the customer profile 122.

The decision engine 124 can receive the customer profile 122 from the one or more generators 120. The decision engine 124 can be a software module that can generate a decision 126 based on the customer profile 122. In one example, the decision engine 124 can be a scoring engine, and the decision 126 can be a score. The score can be a numeric number between a lower limit value and an upper limit value, and/or one or more alphabets, such as a letter grades. An entity (for example, a retailer or a financial institution, such as a bank) can use the score to make one or more offers to a customer 102. The offers can include: an increase in a credit line of a credit card of the customer 102, and discounts on one or more products available for purchase by the customer 102. The entity can also use the score to determine credit card fraud, debit card fraud, attrition, behavioral risk, and/or the like. In some variations, the decision 126 can be an objective recommendation recommending whether an entity (for example, a financial institution, a business unit, or any other entity) should perform a certain function associated with the customer 102, such as open a savings account for the customer 102, open a credit card account for the customer 102, initiate a business deal with the customer 102, provide coupons (for example, discount coupons) to the customer 102, and/or the like.

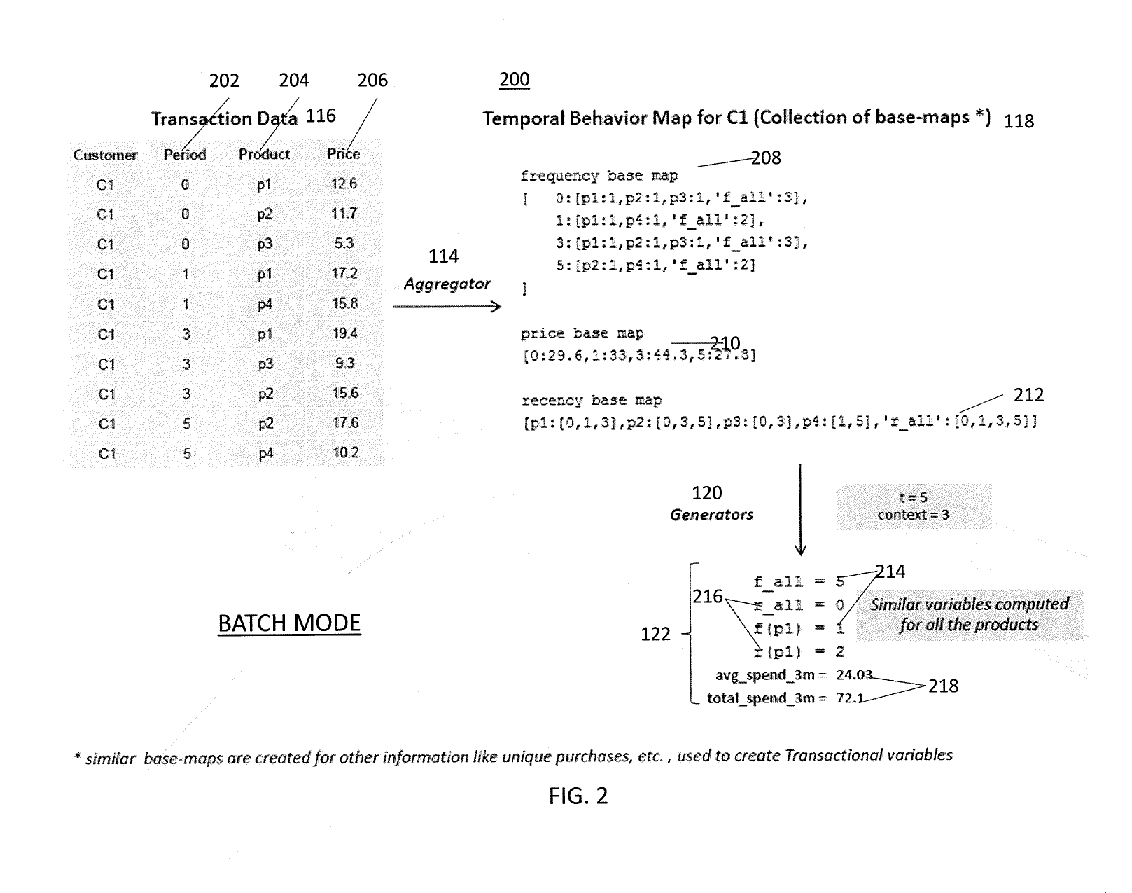

FIG. 2 illustrates an example 200 of the process 100 for generating a customer profile 122 in a batch-mode based on a batch of transactions performed by a customer 102 and generating a decision 126 for the customer 102 based on the customer profile 122. The aggregator 114 can receive sorted transaction data 116 for a batch of transactions performed by a particular customer C1, for which a customer profile is to be generated. The sorted transaction data 116 for the customer C1 can characterize periods 202 (that is, numeric values characterizing corresponding time periods) of purchases by the customer C1, products 204 purchased by the customer C1, and a price 206 for each product 204 in the respective period 202. The transaction data can have other fields also like quantity, type of transaction, merchant category code etc. The aggregator 114 can generate temporal behavior maps 118 based on the sorted transaction data 116 for the particular customer. The temporal behavior maps can include at least a frequency base map 208, a price base map 210, and a recency base map 212, which are also described above.

The frequency base map 208 can be represented as a map—{period 202: {product1: frequency of product1 purchases in period 202, product2: frequency of product2 purchases in period 202, product3: frequency of product3 purchases in period 202, product4: frequency of product4 purchases in period 202, Frequency of all products in period 202}, . . . }. Frequency base map can only store information for periods in which a given customer has made at least one purchase. The absence of a period in the base map can be inferred to mean no purchase in that period. This is designed to save memory as the memory does not require storing of zero values. The price base map 210 can be represented as a map—{period 202: total money spent in period 202, . . . }. The price base map 210 can only store information for periods in which given customer has made at least one purchase. The absence of a period in the base map is inferred to mean no purchase in that period. This is designed to save memory as the memory does not require storing zero values. The recency base map 212 can be represented as a map—{product1: list of periods in which the product1 is purchased, product2: list of periods in which the product2 is purchased, product3: list of periods in which the product3 is purchased, product4: list of periods in which the product4 is purchased, . . . }. Using temporal behavior maps 118 can be advantageous over traditional approaches, as generation of the customer profile 122 using temporal behavior maps 118 requires significantly less number of iterations while additionally, each iteration is faster due to pre-computation.

One or more generators 120 can receive the temporal behavior maps 118 from the aggregator 114. The one or more generators can include a frequency generator, a recency generator, and a transaction variables generator, which are described above. The one or more generators 120 can compute frequency variables 214, recency variables 216, and transaction variables 218 of the customer profile 122 of the particular customer 102, as described above. The shown term t refers to period 202, and context refers to the observation time window (noted above), which can be expressed in terms of periods 202. These computed variables can be provided as an input to a decision engine 124 that can generate a decision 126 (for example, a score) based on these variables.

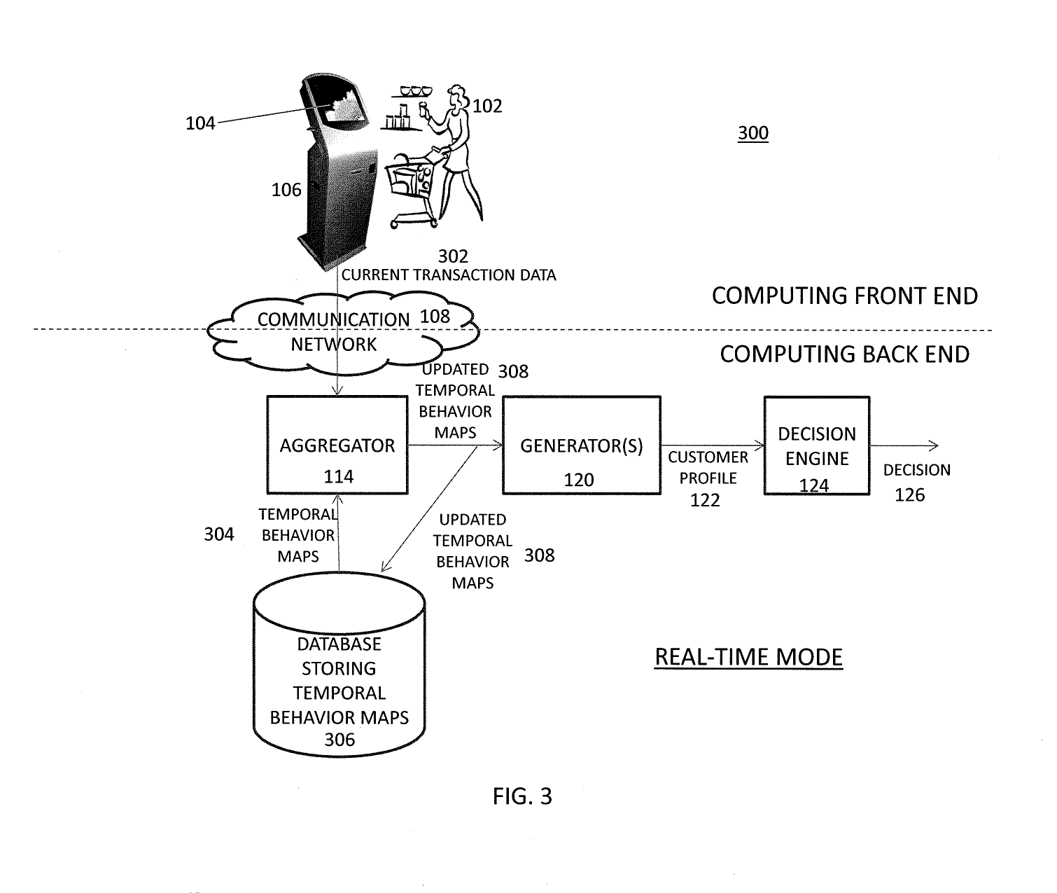

FIG. 3 illustrates a process 300 for generating a customer profile 122 in real-time based on an individual transaction performed by a customer 102 and generating a decision 126 for the customer 102 based on the customer profile 122. When the customer 102 performs a transaction, the transaction processing application 104 can send transaction data 302 of the current transaction to the aggregator 114 in real-time via the communication network 108. The aggregator 114 can retrieve temporal behavior maps 304 of the customer 102 generated before the transaction from the database 306. However, when the aggregator 114 is initialized and no previously generated temporal behavior maps exist in the database 306, initial temporal behavior maps 304 can be generated using a maturation process. The maturation process can occur in a batch mode while other actions after the maturation process occur in real-time or incremental mode. The aggregator 114 can then combine the current transaction data 302 and the temporal behavior maps 304 to generate updated temporal behavior maps 308 for the customer 102. The aggregator 114 can send the updated temporal behavior maps 308 to the database 306 for storage. The aggregator 114 can send the updated behavior maps 308 to the one or more generators 120. The one or more generators 120 can generate the customer profile 122 of the customer 102 based on the updated temporal behavior maps 308.

The one or more generators can send the customer profile 122 to the decision engine 124. The decision engine 124 can generate a decision (for example, a score) for the customer 102 in real-time (that is, immediately after the customer 102 performs a transaction) based on the customer profile 122.

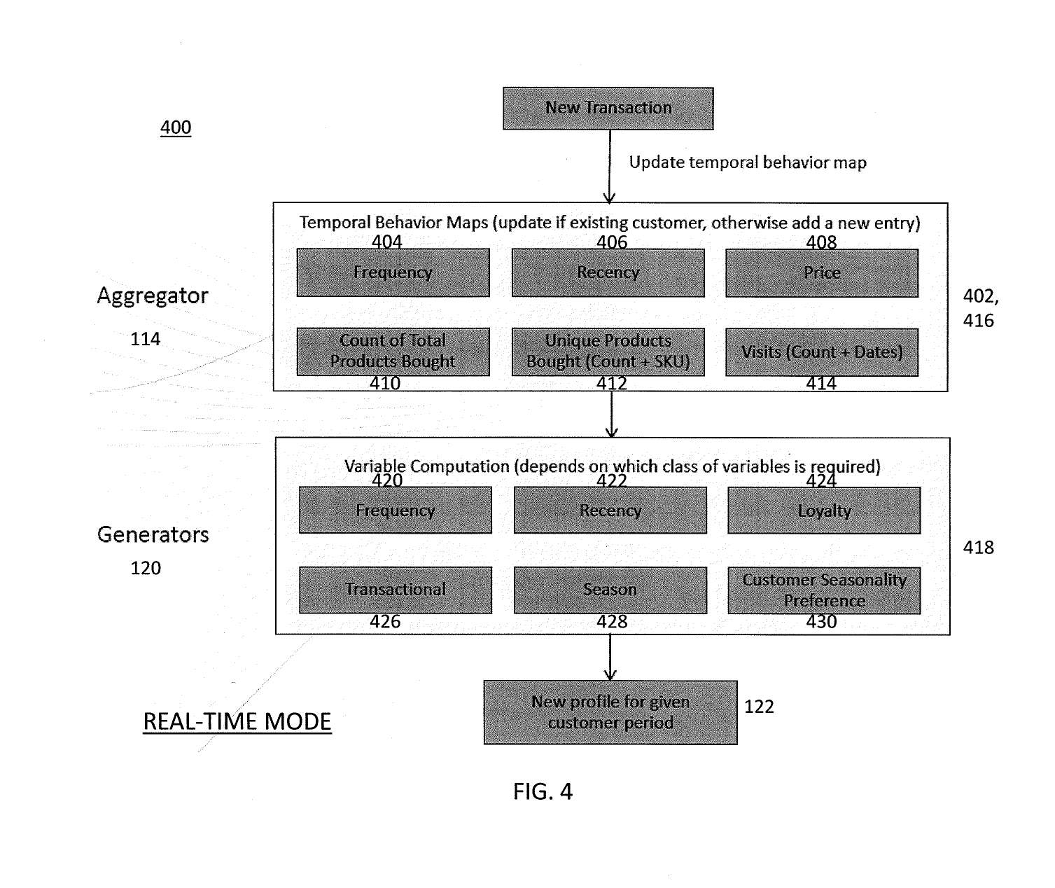

FIG. 4 illustrates a process flow diagram 400 for generating a customer profile 122 in real-time based on an individual transaction performed by a customer 102. When the customer 102 performs a transaction, the transaction processing application 104 in the computing front-end can send transaction data 302 of the current transaction to the aggregator 114 in real-time via the communication network 108. The aggregator 114 can retrieve temporal behavior maps 402 of the customer 102 generated before the transaction from the database 306. The temporal behavior maps 402 can include a frequency base map 404, a recency base map 406, a price base map 408, a counts of total product bought base map 410, a unique products bought base map 412, and a visits base map 414. These base maps are described above in more detail. The aggregator 114 can then combine the current transaction data 302 and the temporal behavior maps 402 to generate updated temporal behavior maps 416, which can include updated versions of the frequency base map 404, the recency base map 406, the price base map 408, the counts of total product bought base map 410, the unique products bought base map 412, and the visits base map 414.

The aggregator 114 can send the updated behavior maps 416 to the one or more generators 120. The one or more generators 120 can generate the customer profile 122 of the customer 102 based on the updated temporal behavior maps 416. The customer profile 122 can be characterized by characteristics or variables 418, which can include frequency variables 420, recency variables 422, loyalty variables 424, transaction variables 426, season variables 428, and customer seasonality preference variables 430. The one or more generators can send the customer profile 122 to the decision engine 124. The decision engine 124 can generate a decision (for example, a score) for the customer 102 in real-time (that is, immediately after the customer 102 performs a transaction) based on the customer profile 122.

The temporal behavior maps described herein can be extensible and scalable. More specifically, a new class of characteristics or variables can be added, if required. These new class of characteristics or variables can work on an existing temporal base map. This new class of variables can be coded in the generator 120, can be used to define one or more interfaces, and can run through various tests while testing the system including at least the aggregator 114 and the generator 120. The calling of the script can reference the new class through the defined one or more interfaces. Further, a new summarization can be added, when necessary. For example, a new base map can be defined on existing data elements in the aggregator 114. New one or more classes of variables can also be added. Furthermore, a new data element can be added. For example, the input data interface and/or a new summarization (as noted above) can be added.

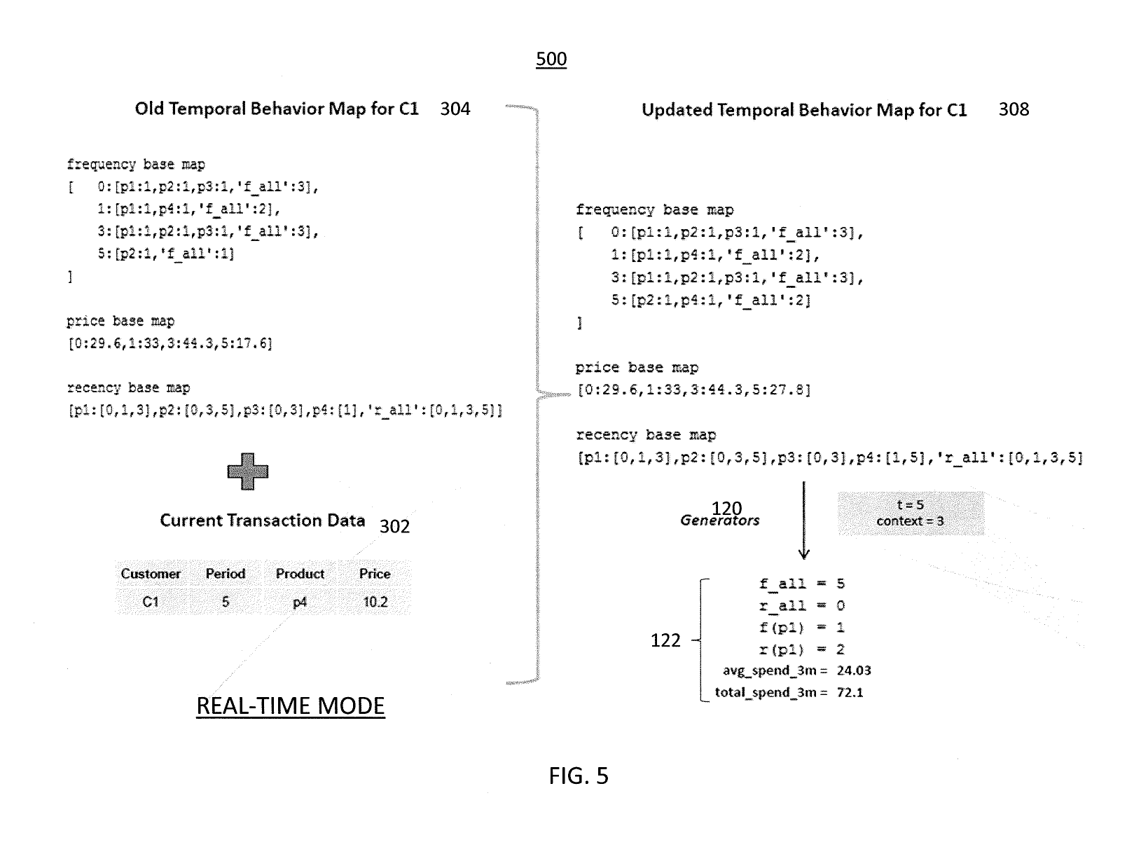

FIG. 5 illustrates an example 500 of a process 300 for generating a customer profile 122 in real-time based on an individual transaction performed by a customer 102 and generating a decision for the customer 102 based on the customer profile 122. When the customer 102 performs a transaction, the transaction processing application 104 can send transaction data 302 of the current transaction to the aggregator 114 in real-time via the communication network 108. The aggregator 114 can retrieve temporal behavior maps 304 of the customer 102 generated before the transaction from the database 306. However, when the aggregator 114 is initialized and no previously generated temporal behavior maps exist in the database 306, initial temporal behavior maps 304 can be generated using a maturation process. The maturation process can occur in a batch mode while other actions after the maturation process occur in real-time or incremental mode. The aggregator 114 can then combine the current transaction data 302 and the temporal behavior maps 304 to generate updated temporal behavior maps 308 for the customer 102. The aggregator 114 can send the updated temporal behavior maps 308 to the database 306 for storage. The aggregator 114 can send the updated behavior maps 308 to the one or more generators 120. The one or more generators 120 can generate the customer profile 122 of the customer 102 based on the updated temporal behavior maps 308, as discussed above. The one or more generators can send the customer profile 122 to the decision engine 124. The decision engine 124 can generate a decision (for example, a score) for the customer 102 in real-time (that is, immediately after the customer 102 performs a transaction) based on the customer profile 122.

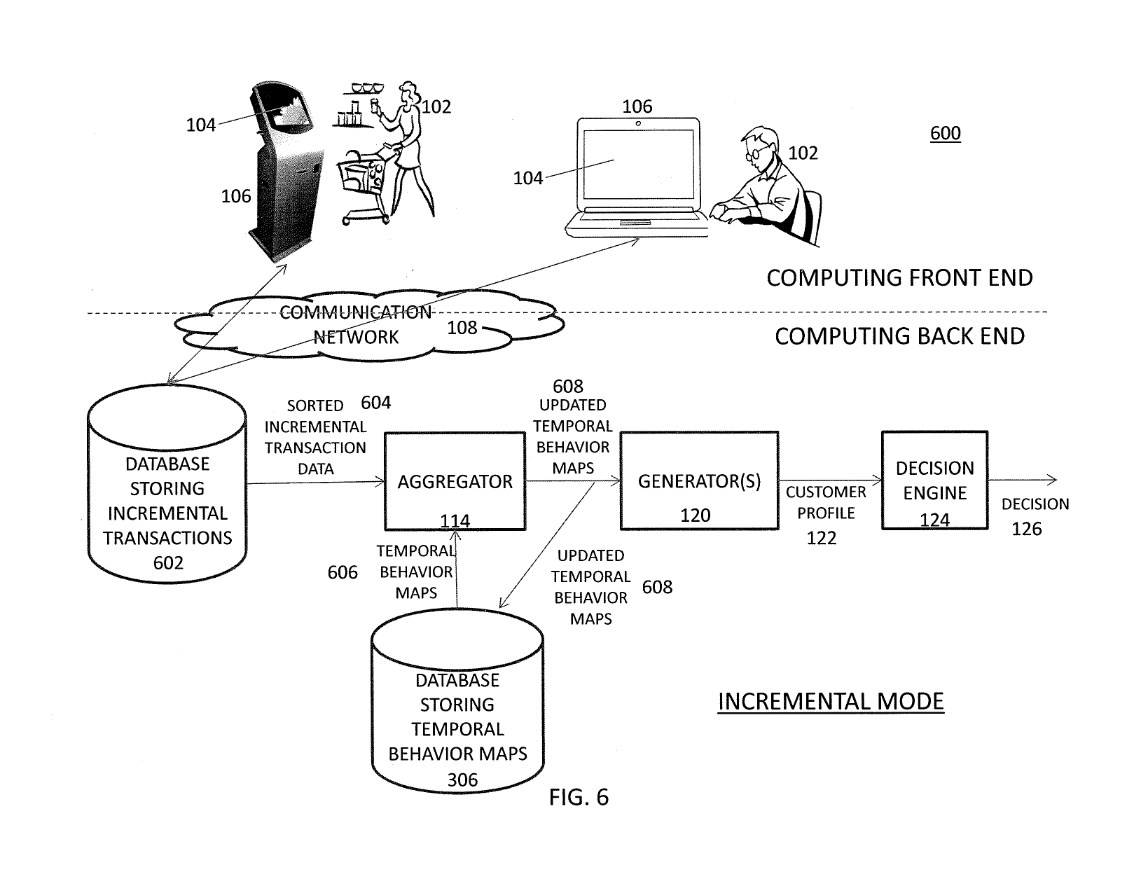

FIG. 6 illustrates a process 600 for generating a customer profile 122 in real-time in an incremental mode based on a constantly updating batch of transactions performed by a customer 102 and generating a decision 126 for the customer 102 based on the customer profile 122. The incremental mode is a fusion of a batch mode and a real-time mode.

When the customer 102 performs a transaction, the transaction processing application 104 can send transaction data 302 of the current transaction to the database 602 via the communication network 108. The database 602 can keep storing new transaction data for each new transaction in real-time. The aggregator 114 can receive a batch of sorted incremental data 604 for the particular customer 102 in real-time. The aggregator 114 can retrieve temporal behavior maps 606 of the customer 102 generated before the transaction from the database 306. However, when the aggregator 114 is initialized and no previously generated temporal behavior maps exist in the database 306, initial temporal behavior maps can be generated using a maturation process. The maturation process can occur in a batch mode while other actions after the maturation process occur in real-time or the incremental mode. The aggregator 114 can then combine the sorted incremental transaction data 604 and the temporal behavior maps 304 to generate updated temporal behavior maps 608 for the customer 102. The aggregator 114 can send the updated temporal behavior maps 608 to the database 306 for storage. The aggregator 114 can send the updated behavior maps 608 to the one or more generators 120. The one or more generators 120 can generate the customer profile 122 of the customer 102 based on the updated temporal behavior maps 608, as discussed above.

The one or more generators can send the customer profile 122 to the decision engine 124. The decision engine 124 can generate a decision (for example, a score) for the customer 102 based on the customer profile 122.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other embodiments may be within the scope of the following claims.

What is claimed is:

1. A method comprising:
receiving, by one or more back-end server computers, transaction data of one or more transactions performed by a customer, each computer comprising memory and at least one data processor;
generating, by the one or more back-end server computers and based on the transaction data, a plurality of temporal behavior maps characterizing purchase behavior of the customer; and
generating, by the one or more back-end server computers, a customer profile of the customer based on the plurality of temporal behavior maps, the customer profile being used by a decision engine to generate a decision for the customer, the decision engine comprising at least one data processor connected to the one or more back-end computers.

2. The method of claim 1, wherein:
the one or more back-end server computers comprise an aggregator module and a generator module that is connected to the aggregator module, the decision engine being connected to the generator module;
the aggregator module receives the transaction data of the one or more transactions performed to generate the plurality of temporal behavior maps; and
the generator module receives the plurality of temporal behavior maps to generate the customer profile.

3. The method of claim 2, wherein the aggregator module receives the transaction data in real-time when the customer performs a new transaction.

4. The method of claim 2, wherein the aggregator module receives the transaction data in a batch comprising a plurality of transactions previously performed by the customer.

5. The method of claim 2, wherein the aggregator module receives the transaction data in batches of continuously updating transactions performed by the customer in real-time.

6. The method of claim 1, wherein the one or more transactions are performed by the customer on a front end client computer connected to the one or more back-end server computers via a communication network.

7. The method of claim 1, wherein the transaction data comprises an identifier of the customer, period of each transaction, one or more products purchased by the customer in each transaction, a price of each purchased product, quantity of products purchased by the customer, transaction type of each transaction performed by the customer, and merchant category code of one or more merchants associated with each transaction.

8. The method of claim 1, wherein the plurality of temporal behavior maps comprise one or more of at least a frequency base map, a recency base map, a price base map, a total products base map, a unique products base map, a visits base map, a stock keeping unit (SKU) base map, and a date base map.

9. The method of claim 8, wherein the frequency base map is represented as a map of {period: {product1: frequency, product2: frequency, . . . }}.

10. The method of claim 8, wherein the recency base map is represented as a map of {product: {list of periods in which the product is purchased}}.

11. The method of claim 8, wherein the price base map is represented as a map of {period: total money spent in the time period, . . . }.

12. The method of claim 8, wherein the total products base map is represented as a map of {period: total number of products purchased, . . . }.

13. The method of claim 8, wherein the unique products base map is represented as a map of {period: number of unique products purchased, . . . }.

14. The method of claim 8, wherein the visits base map is represented as a map of {period: total number of customer visits, . . . }.

15. The method of claim 8, wherein the stock keeping unit (SKU) base map is represented as a map of {period: list of unique SKUs purchases by customer, . . . }.

16. The method of claim 8, wherein the date base map is represented as a map of {period: date of most recent purchase, . . . }.

17. The method of claim 2, wherein the generator module comprises a frequency generator, a recency generator, and a transaction variables generator.

18. The method of claim 17, wherein:
the frequency generator generates one or more frequency variables based on a frequency base map of the plurality of temporal behavior maps;
the recency generator generates one or more recency variables based on a recency base map; and
the transaction variables generator generates one or more transaction variables based on at least one of a price base map, a total products base map, a unique products base map, a visits base map, a stock keeping unit (SKU) base map, and a date base map of the plurality of temporal behavior maps.

19. The method of claim 18, wherein the customer profile is characterized by at least the one or more frequency variables, the one or more recency variables, and the one or more transaction variables.

20. The method of claim 1, wherein the decision engine is a scoring engine, and the decision is a score generated by the scoring engine.

21. The method of claim 20, wherein the score is used by one of a financial institution and a retailer to make an offer to the customer.

22. The method of claim 21, wherein the offer comprises one of: an increase in a credit line of a credit card of the customer, and discounts on one or more products.

23. A non-transitory computer program product storing instructions that, when executed by at least one programmable processor forming a part of at least one computing device, cause the at least one programmable processor to perform operations comprising:
receiving a customer profile of a customer characterizing one or more behavioral characteristics of the customer, the customer profile being based on one or more temporal behavior maps characterizing a purchase behavior of the customer over discrete periods of time, the one or more temporal behavior maps being based on one or more transactions performed by the customer; and
generating, based on the customer profile, a decision for the customer for use by an entity to make one or more offers to the customer.

24. The computer program product of claim 23, wherein the entity is one of a financial institution and a retailer.

25. The computer program product of claim 23, wherein the one or more offers comprise one or more of: an increase in credit line of a credit card of the customer, and discounts on one or more products.

26. A system comprising:
a client computing system comprising at least one hardware data processor and a storage memory device, the client computing system being used by a customer to perform one or more transactions; and
one or more back-end server computers connected to the client computing system via a communication network, the one or more back-end server computers receiving transaction data of the one or more transactions performed on the client computing system, the one or more back-end server computers generating a plurality of temporal behavior maps based on the transaction data, the temporal behavior maps characterizing a purchase behavior of the customer, the one or more back-end server computers generating a customer profile of the customer based on the plurality of temporal behavior maps, the customer profile being used by a decision engine to generate a decision for the customer, the decision engine comprising at least one data processor connected to the one or more back-end computers.

27. The system of claim 26, wherein:
the one or more back-end server computers comprise an aggregator module and a generator module that is connected to the aggregator module, the decision engine being connected to the generator module;
the aggregator module receives the transaction data of the one or more transactions performed to generate the plurality of temporal behavior maps; and
the generator module receives the plurality of temporal behavior maps to generate the customer profile.
